(19) United States
(12) Patent Application Publication
(10) Pub. No.: US 2009/0249192 A1
(43) Pub. Date: Oct. 1, 2009

(54) CREATING A VIEW FROM MULTIPLE TEMPLATES

(75) Inventors: Gregory L. Chan, Seattle, WA (US); Zhenguang Chen, Woodinville, WA (US); Richard Eric Andeen, Kirkland, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/059,492

(22) Filed: Mar. 31, 2008

(51) Int. Cl. G06F 17/00

(52) U.S. Cl. 715/235

(57) ABSTRACT

Instead of using a single template to define a view, multiple interchangeable templates are selected to create a view. The interchangeable templates are shareable across different views which helps in creating different views without requiring users to hard code the changes to the view within a single template. The selected interchangeable templates defining the view are accessed and used to render the display of the view.

### BACKGROUND

A stylesheet is often created to define how to transform a source document into an output document that is displayed within a web browser. One example of a stylesheet is an eXtensible Stylesheet Language (XSL) stylesheet that defines a set of rules that determine how to transform a source eXtensible Markup Language (XML) document into an output document that is displayed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Instead of using a single template to define a view, multiple interchangeable templates are used to create a view. The interchangeable templates are shareable across different views which assists in creating different views without requiring users to hard code the changes to the code in the stylesheets to create the different view. The interchangeable templates defining the view are accessed and then used to render the display of the view.

### BRIEF DESCRIPTION OF THE DRAWINGS

FIG. 1 illustrates an exemplary computing system;

FIG. 2 shows combining multiple templates to create a view;

FIG. 3 illustrates an exemplary editor that may be used to select multiple templates to create a view;

FIG. 4 shows a process for creating a view using multiple templates; and

FIG. 5 illustrates an example of creating a view from multiple templates.

### DETAILED DESCRIPTION

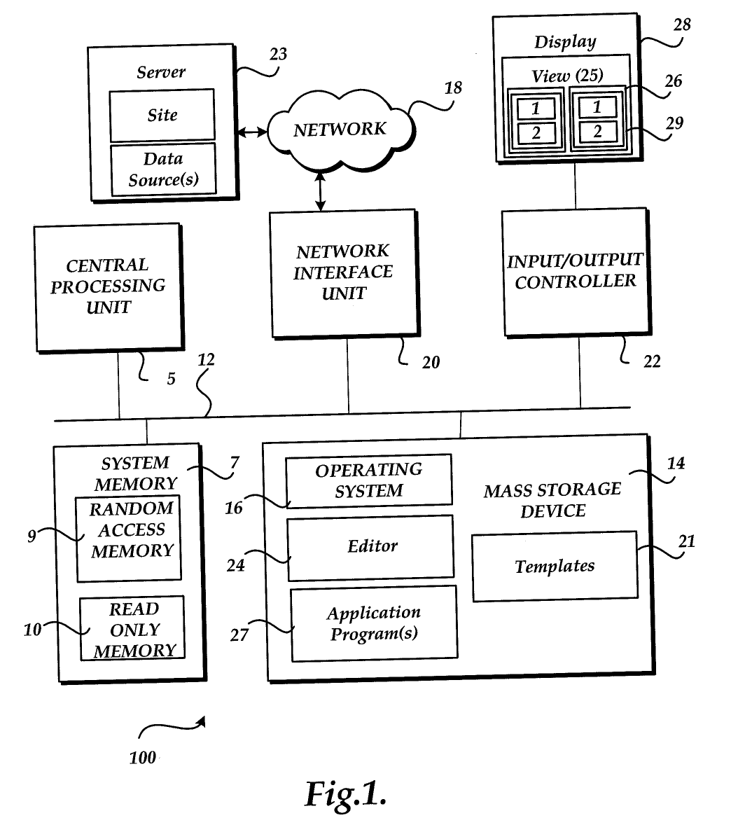

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. While computer 100 is generally illustrated as a client computing device, computer 100 may be configured as a client, a server, mobile device, or any other computing device that is used to provide and/or interact with a view created from multiple templates. Computer 100 includes a central processing unit 5 (“CPU”), a system memory 7, including a random access memory 9 (“RAM”) and a read-only memory (“ROM”) 10, and a system bus 12 that couples the memory to the CPU 5. A basic input/output system containing the basic routines that help to transfer information between elements within the computer, such as during startup, is stored in the ROM 10. The computer 100 further includes a mass storage device 14 for storing an operating system 16, application programs 27, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide output to a display screen 28, a printer, or other type of output device. Computer 100 may also be coupled to data source(s) through a network connection 18, and/or some other connection.

As mentioned briefly above, a number of program modules and data files may be stored in the mass storage device 14 and RAM 9 of the computer 100, including an operating system 16 suitable for controlling the operation of a networked personal computer, such as the WINDOWS VISTA® operating system from MICROSOFT CORPORATION of Redmond, Wash. The mass storage device 14 and RAM 9 may also store one or more program modules. In particular, the mass storage device 14 and the RAM 9 may store an editor program 24, one or more application programs 27, such as a web browser application and templates 21 that are used to create a view. A web browser program may be the MICROSOFT INTERNET EXPLORER® application.

Server 23 is configured to provide site services. As illustrated, server 23 is configured to provide a site that is accessed through browser application 24 on client 100. According to one embodiment, site software, such as MICROSOFT SHAREPOINT SERVICES®, may be used. The site may be configured as an Internet Site, Extranet Site, and/or an Intranet site or any other site that is accessible to users.

Display 28 is used to display the view created from multiple templates, such as combining templates 21. Templates may also be stored at other data stores. For example, templates may be stored at server 23. The templates may be selected many different ways. For example, the templates 21 may be selected through a user interface, programmatically, or manually by specifying the templates. An editing program 24 could be accessed to provide a user with a visual way to select the multiple templates that are used to create the view. For example, a User Interface (UI) associated with the editing program may be used to select templates from a set of interchangeable templates 21 to create one or more views. Instead of using a single template to define a single view, multiple templates are selected from sets of interchangeable templates to create a view. The interchangeable templates are shareable across different views which helps in creating different views without requiring users to have to hard code the changes to the view. As illustrated in FIG. 1, display 28 includes a view that uses a view template 25, an item template 26, and a field template 29. The UI may also be used to make modifications/additions to the content of the site. More details on creating a view from multiple templates is described below.

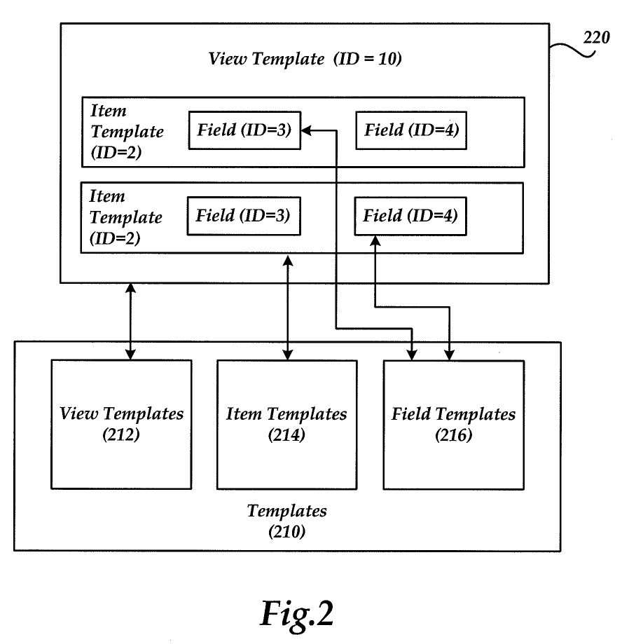

FIG. 2 shows combining multiple templates to create a view.

To create a view, multiple templates are selected from templates 210 and then used to create view 220. As illustrated, view 220 shows two items arranged in a row each having two fields. View 220 is defined by a view template 212, an item template 214, and one or more field template(s) 216.

The templates within each set of templates (i.e. 212, 214, and 216) are interchangeable. In other words, any of the templates may be interchanged with another template of the same type to create a different view. A user may select the templates to create the view many different ways. For example, a user may select the templates through a program; an application programming interface (API), by specifying the templates in a file, and the like. According to one embodiment, the templates that are selected are identified by an associated unique identifier. In the present example, the view template selected is identified by ID=10. The item template is identified by ID=2 and the field templates are identified by ID=3 and ID=4. While three different template types are illustrated, other template types may be utilized. For example, two or more template types may be used, four or more types, and the like.

The view templates 212 provide the overall look and feel for the view by defining the overall arrangement of the data in the view. For example, each view template may correspond to a specific type of view, such as a newsletter view; a magazine view; a spreadsheet view; and the like. Many variations of each view template may be provided.

The item templates 214 provide the definitions for displaying the items within the overall view defined by the selected view template. The item template may define to display the items in a row, column, box, or some other display method. For example, one item template may define to display the items in a row, another item template may display the items in a column, another in two columns, and the like. An item may relate to any type of data, such as: tasks; contacts; users; customers; and the like.

The field templates 216 provide the definitions for formatting one or more fields that are associated with an item. For example, a field template may define to display a particular type of field one way (i.e. a phone number type using a 10 point bold font); another field template may define to display a range of types a certain way; and the like.

According to one embodiment, the templates (view templates 212, item templates 214, and field templates 216) are XSLT templates. XSLT templates are “schema agnostic”, meaning that they adapt to the schema of the associated data source. For example, fields can be added or removed or their data type may change, and the XSLT template still renders the view correctly. The term “XSL” is commonly used to refer to a group of related technologies, including XSL Transformations (XSLT), XPath, and XSL Formatting Objects. The term “stylesheet” in the context of XSL includes rules for all types of transformation, and it is intended that the broader aspect of the term shall apply herein.

A transformation stylesheet defines how to transform a source document into an output document. For instance, an XSL stylesheet has a set of rules that determine how to transform a source XML document into an output document. The output document may also be an XML document, or may be another type of document, such as a Hypertext Markup Language (HTML) document, a Portable Document Format (PDF) document and the like. Typically, an XSL stylesheet defines the formatting style of the output document, such as text color, line spacing, etc. However, an XSL stylesheet may also define alterations that transform the structure of the source document into a different structure. For example, the structure of nodes in a source XML document may be transformed according to the XSL stylesheet to produce an output XML document with nodes arranged in a different order, or replaced with different nodes altogether. Similarly, the structure of a source XML document may be transformed according to the XSL stylesheet to produce an output HTML document that is structurally different and not just translated into HTML. Thus, a source document can not only be transformed into an output document according to formatting rules that are included in an XSL stylesheet, but more broadly, the XSL stylesheet can be used to transform the source document in many other aspects, beyond just formatting.

An XSL stylesheet can be employed to transform various source documents containing different information into a single desired uniform output structure and format. An XSL stylesheet is also useful for transforming a large amount of source data into a structure and format desired for display in a Web browser program.

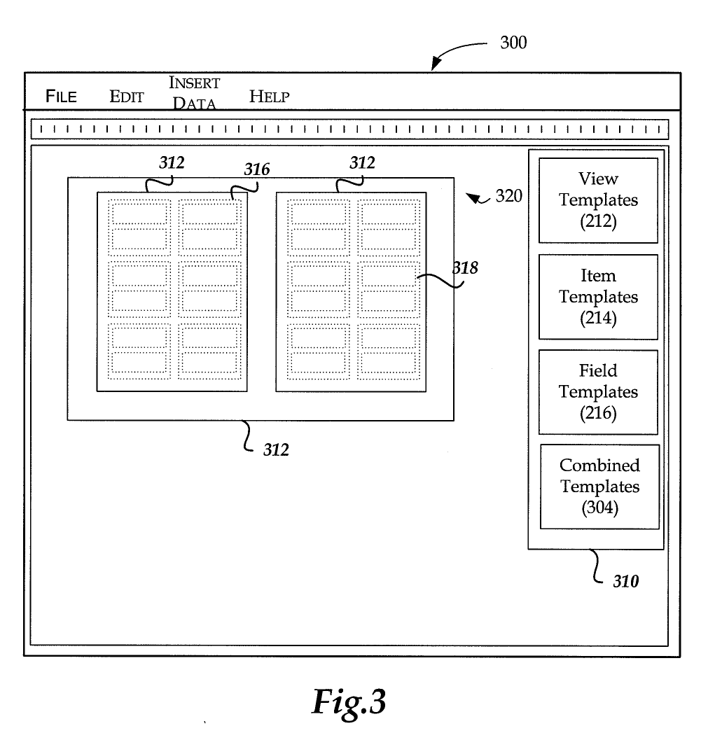

FIG. 3 illustrates an exemplary editor that may be used to select multiple templates to create a view.

As illustrated, a view may be created through a user interface associate with an application, such as editor 300. An editor may include many different menus, toolbars, and the like to interact with creating/defining/modifying a view. For example, task pane 310 may be used to display the available interchangeable templates that are used to define view 320. The source data that is transformed by the multiple templates used to create view 320 may be available in a data store, such as a separate file, a database, or some other data store. The source data is often a dynamic source of data (i.e., subject to change on a frequent basis). For example, a data source may store order information and the status of orders. The source data may be associated with the selected templates (i.e. view template 312, item template 316 and field template 318) while the templates are being selected to create view 320 or at any point after the view 320 is created.

As discussed above, XSL is often used to transform source data into a desired format and a desired structure for display as a view in a Web document. Editor 300 may be configured to provide functions for defining and modifying such data transformations for use in a currently open Web document. Often, a user will first wish to associate source data, such as a list in a data collaboration system, such as MICROSOFT SHAREPOINT® with the currently open Web document. The user may select an insert data function to establish this association. For instance, when a insert data function is selected a task pane may display a catalog of data sources (not shown). The user may organize the data source catalog as desired, and populate the catalog with any desired data sources. For example, the user may select one or more XML files as a data source.

In the example shown, editor 300 shows a layout of a view of a Web document as it would appear if displayed by a browser program. To create view 320, the user selects a view template (312) from view templates 212, an item template (316) from item templates 214 and a field template(s) 318 from field template 216. Alternatively, a user may select a combined template from combined templates 304. A combined template is a template that has already made selections of a view template, an item template and field templates. A user may also select a combined template and then replace one or more of the selected templates with the another template from the appropriate template category.

A view created from the templates selected could be a simple view (i.e. a simple record-oriented layout, such as tabular and stacked fields) or a complex view. Conditional formatting features may also be associated to select an appropriate template to create the view. The conditional formatting feature allows conditions to be set on selected items in the data view and for those items to be shown, hidden, or have a formatting style applied to the selected items based on the condition. The transformation instructions that are contained in the selected templates (i.e. XSL stylesheets) are applied to the source data to generate view 320.

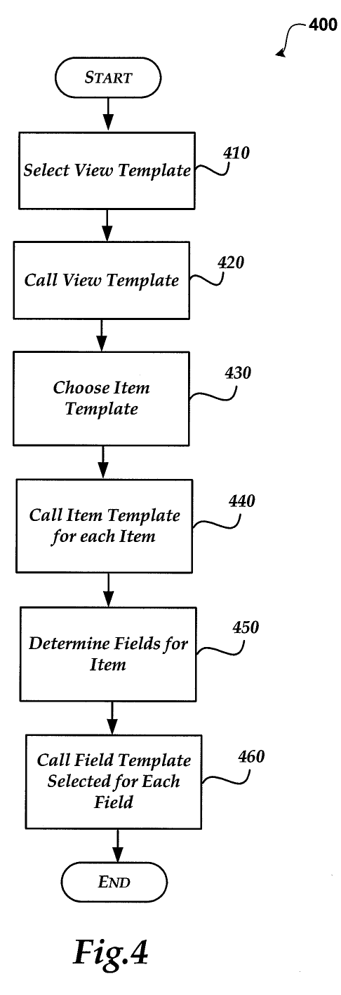

Referring now to FIG. 4, an illustrative process for creating a view using multiple templates is described.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, process 400 flows to operation 410, where a view template is selected. The view template defines the overall look and feel of the view. For example, the view template may be defined to create a look and feel of a newsletter, a business report, an informal display, and the like. According to one embodiment, the view template is the highest template in a hierarchical arrangement of the templates used to create the view.

Flowing to operation 420, the selected view template is called to execute the code that is included in the template. According to one embodiment, the view template, and the other templates used in creating the view, are coded using XSL. Other languages may also be used.

Moving to operation 430, the item template is selected. The item level provides the definition of how to display the items within the view. For example, the item template may specify to display the items within a box, a row, a column, and the like.

Transitioning to operation 440, the selected item template is called to execute the code that is included in the template. According to one embodiment, the item template is called for each instance of an item that is to be rendered. For example, when ten items are to be rendered then the item template is called ten times.

Flowing to operation 450, the fields that are associated with the items are determined. For example, one type of item may contain five fields, another item type may contain four fields, and the like. An illustrative example, would be a contact item that could include a name field, an address field, a home phone number field, a mobile phone number field, and an email address. Each field within an item may be displayed differently depending on the field template(s) that are selected. For example, one field template may format a phone number differently from another field template and one field template may format an address differently.

Moving to operation 460, the field template that is selected for each of the fields in the item is called to apply the desired formatting to the field.

The process then flows to an end operation and returns to processing other actions.

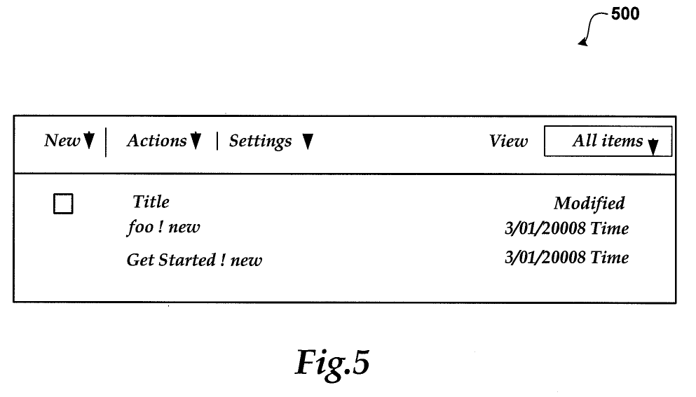

FIG. 5 illustrates an example of a view 500 created from multiple templates.

The following example code is illustrative of creating a view that shows a simple tabular view with a toolbar and two items with two fields. The example code is for illustration purposes only and is intended to not be limiting.

```
<xsl:template match=“/”>
  <xsl:apply-templates mode=“RootTemplate” select=“$XmlDefinition”/>
</xsl:template>
<xsl:template mode=“RootTemplate” match=“View”>
  <table width=“100%” cellspacing=“0” cellpadding=“0” border=“0”>
    <tr>
      <td>
        <table Summary=“{List/@title}” width=“100%” border=“0”
        cellspacing=“0”>
          <xsl:apply-templates select=“.” mode=“full” />
        </table>
      </td>
    </tr>
  </table>
</xsl:template>
<xsl:template mode=“Item” match=“Row”>
  <xsl:param name=“Fields” select=“.”/>
  <tr>
    <xsl:for-each select=“$Fields”>
      <td>
        <xsl:apply-templates select=“.”>
          <xsl:with-param name=“thisNode” select=“$Fields”/>
        </xsl:apply-templates>
      </td>
    </xsl:for-each>
  </tr>
</xsl:template>
<xsl:template match=“FieldRef[@Type=‘Text’]”>
  <xsl:param name=“thisNode” select=“.”/>
  <xsl:value-of select=“$thisNode/@*[name( )=current( )/@Name]”/>
</xsl:template>
```

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for creating a view from multiple templates, comprising:
specifying templates to define a view of data on a web page; wherein each of the selected templates defines a different component of the view; wherein one of the selected templates is a view template that defines a layout for items in the view and wherein another one of the selected templates defines properties for displaying items within the layout; and wherein the templates are selected from a set of interchangeable templates;
calling each of the selected templates that define the view; and
displaying the view created from the selected templates.

2. The method of claim 1, wherein each the templates is an eXtensible Stylesheet Language (XSL) transform that defines a structure and format for displaying the data within the view.

3. The method of claim 1, wherein the set of interchangeable templates include a set of view templates; a set of item templates; and a set of field templates; wherein each of the field templates defines how to display a field that is included within an item.

4. The method of claim 2, wherein calling each of the selected templates that define the view and displaying the view comprises calling the view template; reading the XSL associated with the view template; rendering the component of the view that is associated with the view template; calling the item template; reading the XSL associated with the item template and rendering the component of the view that is associated with the item template.

5. The method of claim 4, further comprising determining fields within the item; determining a type for each field within the item; and calling a field template for each type within the item to display the fields.

6. The method of claim 1, wherein specifying the templates to define the view comprises specifying each of the selected templates within an eXtensible Markup Language (XML) file.

7. The method of claim 1, wherein the data to view is selected from data that is associated with a data collaboration application.

8. The method of claim 1, further comprising replacing a selected template with another selected template to define a different view.

9. A computer-readable storage medium having computer-executable instructions for creating a view; comprising:
accessing a file that includes references to templates that define a view of data on a web page; wherein the templates comprise a first template that is selected from a first set of interchangeable templates; a second template that is selected from a second set of interchangeable templates and a third template that is selected from a third set of interchangeable templates; wherein the first template defines a first component of the view; the second component defines a second component of the view; and the third template defines a third component of the view;
calling each of the templates that are referenced in the file that define the view of the data on the web page; and
displaying the view.

10. The computer-readable storage medium of claim 9, wherein each of the templates is an eXtensible Stylesheet Language (XSL) transform that defines a structure and format for displaying the data within the view; wherein the first template defines a layout of the data within the view; wherein the second template defines how to display items within the view; and wherein the third template defines how to display a field within an item.

11. The computer-readable storage medium of claim 9, wherein calling each of the templates comprises reading the XSL associated with each of the called templates and rendering the component of the view that is associated with the called template.

12. The computer-readable storage medium of claim 10, further comprising determining fields included within the item; determining a type for each field within the item; and associating a field template for each determined type of field within the item.

13. The computer-readable storage medium of claim 9, further comprising selecting the data from a data store that is associated with a collaboration application.

14. The computer-readable storage medium of claim 9, further comprising replacing a selected template with another selected template to define a different view.

15. A system for creating a view from multiple templates; comprising:
a processor a memory and a computer-readable medium;
an operating environment stored on the computer-readable medium and executing on the processor;
a display that is configured to display a view on a web page;
a data source that is configured to store data; wherein the data includes items; wherein each of the items includes fields; and
an application that is configured to:
access templates that define the view of data on a web page; wherein each of the selected templates defines a different component of the view; wherein one of the selected templates is a view template that defines an arrangement of the data in the view; wherein another one of the selected templates is an item template that defines an arrangement of the items; and wherein another one of the selected templates is a field template that defines how to display the fields within each of the items;
calling each of the accessed templates that define the view; and
displaying the view on the display.

16. The system of claim 15, wherein the view template is selected from a set of interchangeable view templates; wherein the item template is selected from a set of interchangeable item templates and wherein the field template is selected from a set of interchangeable field templates.

18. The system of claim 16, wherein calling each of the accessed templates reading XSL associated with each of the templates and rendering the component of the view that is associated with each of the accessed templates.

19. The system of claim 16, further comprising associating a different field template with each field in the item that is of a different type.

20. The system of claim 16, further comprising replacing an accessed template with another template to create a different view.
